(19) United States
(12) Patent Application Publication
(10) Pub. No.: US 2014/0157383 A1
(43) Pub. Date: Jun. 5, 2014

(54) ACCESS MANAGEMENT SYSTEM AND METHOD

(71) Applicant: HON HAI PRECISION INDUSTRY CO., LTD., New Taipei (TW)

(72) Inventor: YING-XIONG HUANG, New Taipei (TW)

(73) Assignee: HON HAI PRECISION INDUSTRY CO., LTD., New Taipei (TW)

(21) Appl. No.: 13/848,691

(22) Filed: Mar. 21, 2013

(30) Foreign Application Priority Data
Dec. 4, 2012 (TW) 101145548

(51) Int. Cl. H04L 29/06

(52) U.S. Cl. CPC H04L 63/083
USPC 726/7

(57) ABSTRACT

An access management method includes steps of prompting user to input an account and associated password based on a login request; comparing whether the input account and associated password is one of the accounts and the associated password stored in the storage unit; acquiring the plurality of objects linking to the input account and password, and the login account and associated password for each acquired object when the input account and associated password is one of the accounts and associated passwords stored in the storage unit; and logging into one of the objects when the object is accessed.

### BACKGROUND

1. Technical Field

The present disclosure relates to management systems, and particularly to an access management system and method.

2. Description of Related Art

It is often needed to validate an input associated password to acquire access permission when a user open an application associated with a server. However, different applications from different servers usually need different login accounts and associated passwords, it is easy to confuse the user by needing to remember the different login accounts and associated passwords for different applications.

Therefore, what is needed is an access management system to overcome the above described limitations.

### BRIEF DESCRIPTION OF THE DRAWING

FIG. 1 is a schematic diagram of an access management system in accordance with an exemplary embodiment.

FIG. 2 shows relationships between three accounts and associated passwords and objects.

FIG. 3 is a block diagram of the hardware infrastructure of the access management system of FIG. 1, in accordance with an exemplary embodiment.

FIG. 4 is a flowchart of an access management method implemented by the access management system of FIG. 1, in accordance with an exemplary embodiment.

### DETAILED DESCRIPTION

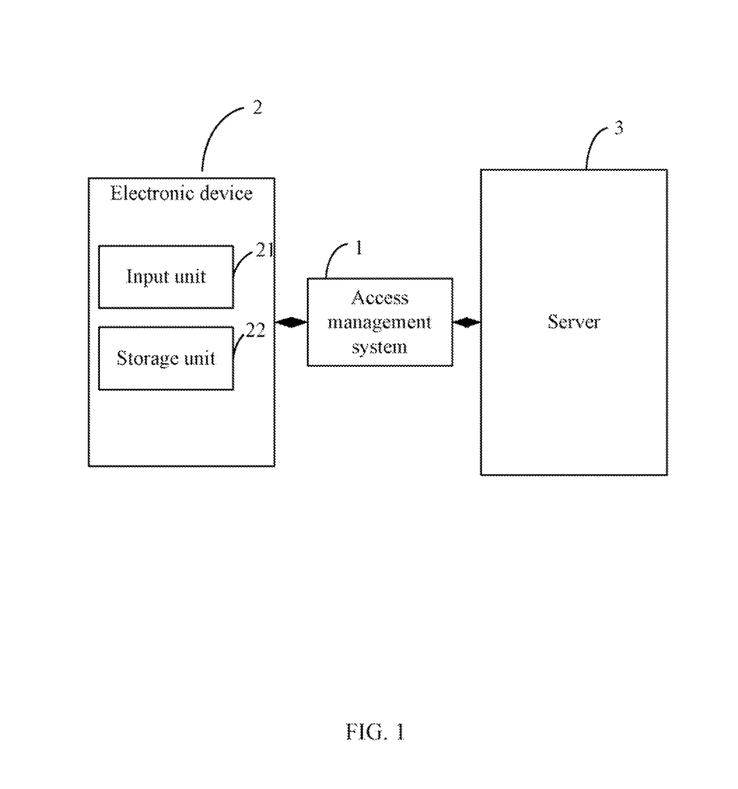

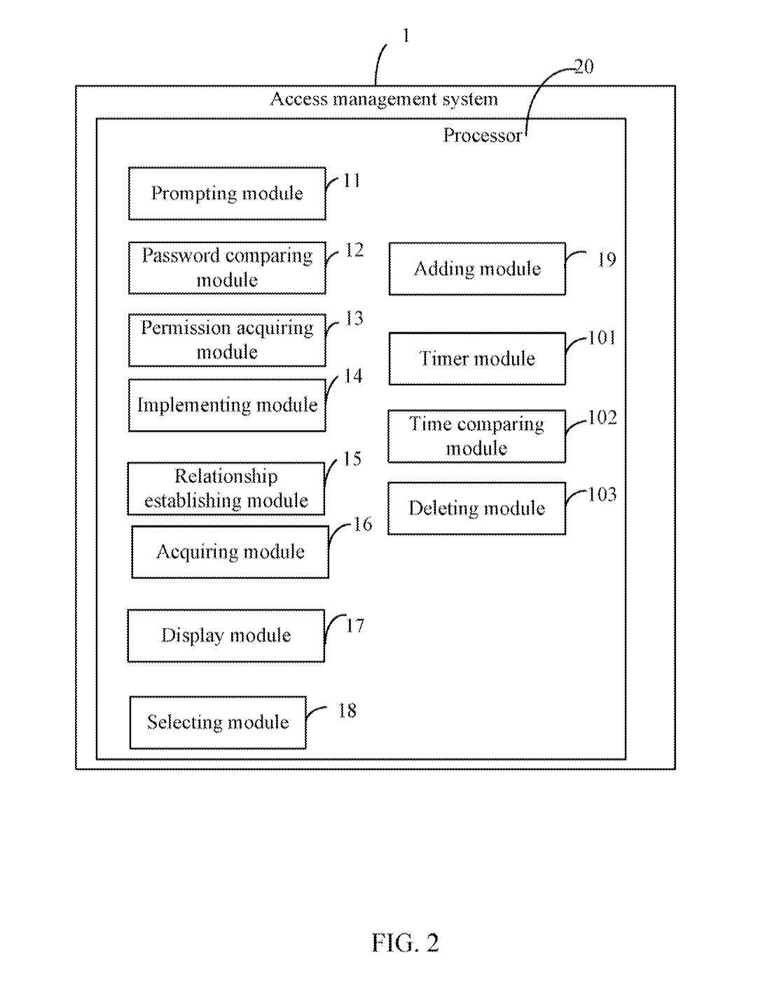

FIG. 1 is an access management system 1 of an exemplary embodiment. The access management system 1 is applied on an electronic device 2 and at least one server 3. The electronic device 2 includes an input unit 21 and a storage unit 22. The input unit 21 receives an account and associated password. The storage unit 22 stores a number of accounts and associated passwords, which are used to login the electronic device 2. Each account and associated password links to a number of objects, e.g., a number of applications or websites. In one embodiment, the object may be applications, network addresses, for example. Each object is assigned a login account and associated password. Each login account and associated password has a permission to access a server corresponding to the object. In one embodiment, the electronic device 2 may be a computer, mobile device, for example. FIG. 2 shows that the storage unit 22 stores three accounts A1, A2 and A3, the objects being linked to the account A1 include B1, B2 and B3, the objects being linked to the account A2 include C1 and C2, and the objects being linked to the account A3 include D1, D2 and D3.

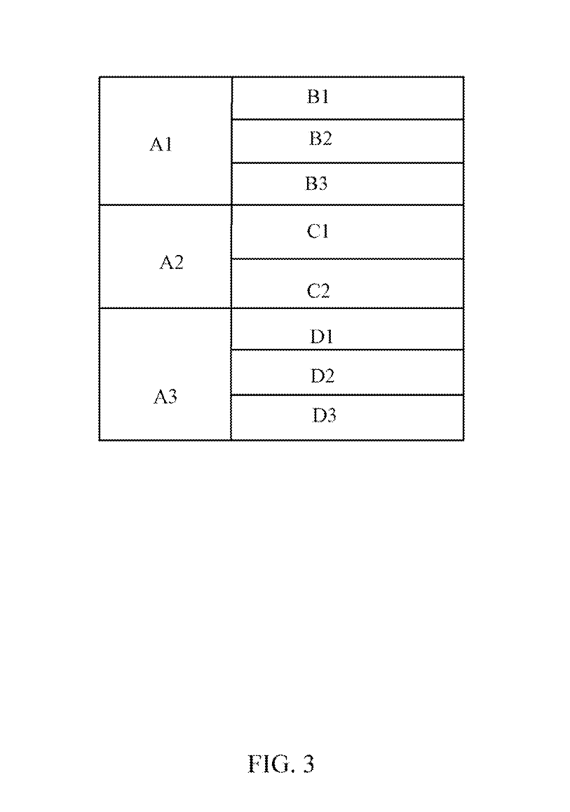

FIG. 3 shows that the access management system 1 includes one or more processors 20 and a number of modules to be executed by the processors 20. The modules include a prompting module 11, a password comparing module 12, a permission acquiring module 13, and an implementing module 14. The prompting module 11 prompts user to input an account and associated password based on a login request. The password comparing module 12 compares whether the input account and associated password is one of the accounts and associated passwords stored in the storage unit 22. The permission acquiring module 13 acquires the number of objects linking to the input account and password, and the login account and associated password for each acquired object when the input account and associated password is one of the accounts and associated passwords stored in the storage unit 22. The implementing module 14 automatically logs in the object when opened. In one embodiment, the prompting module 11, the password comparing module 12, the permission acquiring module 13, and the implementing module 14 run in the electronic device 2.

The number of modules further includes a relationship establishing module 15. The relationship establishing module 15 receives a linking request which includes an object and a login account and associated password for the object, and links the object and the login account and associated password to one of the accounts and associated password in response to the linking request. In one embodiment, the relationship establishing module 15 can run on the electronic device 2 or the server 3. The relationship establishing module 15 further receives an amending request which includes the object and the login account and associated password amendment for the object, and links the object and the amended login account and/or associated password to the account and associated password in response to the amending request. In one embodiment, the number of modules further includes an acquiring module 16, a display module 17, and a selecting module 18. The acquiring module 16 receives the linking request which includes the object and the login account and associated password for the object, and acquires the accounts and associated passwords from the storage unit 22 in response to the linking request. The display module 17 displays the acquired accounts and associated passwords. The selecting module 18 selects one of the accounts and associated passwords in response to a selecting operation. The relationship establishing module 15 links the object and the login account and associated password to the selected account and associated password. In another embodiment, the number of modules further includes an adding module 19. The adding module 19 prompts the user to input a new account and associated password in response to the linking request. The relationship establishing module 15 links the object and the login account and associated password corresponding to the object to the input account and associated password. In one embodiment, the acquiring module 16, the display module 17, the selecting module 18, and the adding module 19 runs on the electronic device 2.

The number of modules further includes a timer module 101, a time comparing module 102, and a deleting module 103. The timer module 101 records a time range between a time when the account and associated password stored in the storage unit 22 is last used and a current time. The time comparing module 102 compares whether the time range is more than a predetermined time range. The deleting module 103 deletes the account and associated password from the storage unit 22 when the time range is more than the predetermined time range. In one embodiment, the timer module 101, the time comparing module 102, and the deleting module 103 run on the electronic device 2.

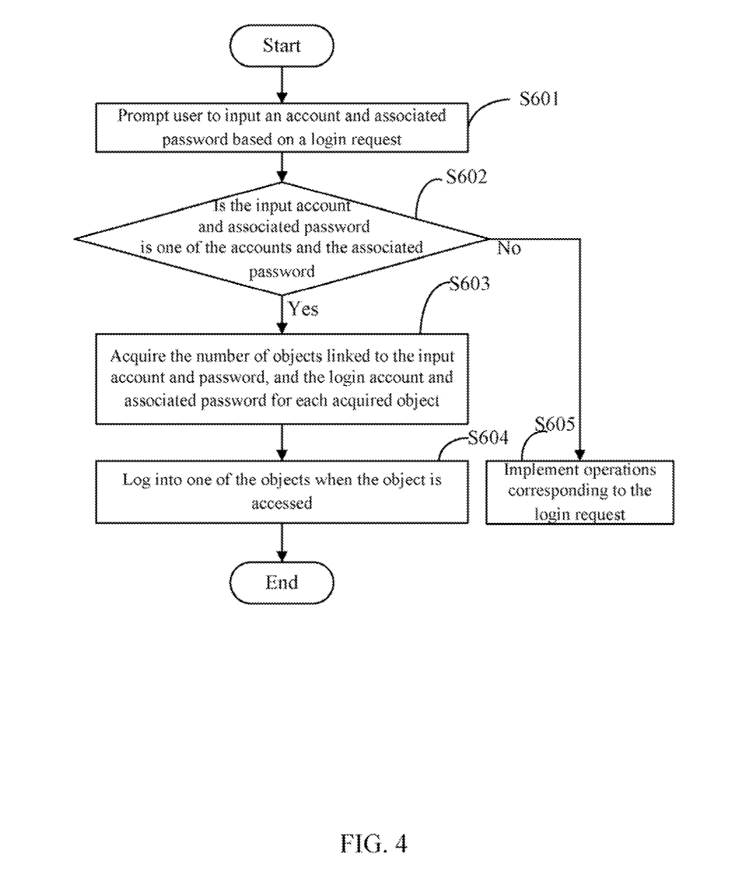

FIG. 4 is a flowchart of an access management method implemented by the access management system of FIG. 1, in accordance with an exemplary embodiment.

In step S601, the prompting module 11 prompts user to input an account and associated password based on a login request.

In step S602, the password comparing module 12 compares whether the input account and associated password is one of the accounts and associated passwords stored in the storage unit 22, if yes, the procedure goes to step S603, if no, the procedure goes to step S605.

In step S603, the permission acquiring module 13 acquires the number of objects linking to the input account and password, and the login account and associated password for each acquired object.

In step S604, the implementing module 14 automatically logs in the object when opened.

In step S605, the implementing module 14 implements operations corresponding to the login request.

The method further includes a sub step: the relationship establishing module 15 receives a linking request which includes an object and a login account and associated password for the object, and links the object and the login account and associated password to one of the accounts and associated password in response to the linking request. The relationship establishing module 15 further receives an amendment request which includes the object and the login account and associated password amendment for the object, and links the object and the amended login account and/or associated password to the account and associated password in response to the amendment request to cover with an original password for the object. In one embodiment, the method further includes sub steps: the acquiring module 16 receives the linking request which includes the object and the login account and associated password for the object, and acquires the accounts and associated passwords from the storage unit 22 in response to the linking request, the display module 17 displays the acquired accounts and associated passwords, the selecting module 18 selects one of the accounts and associated passwords in response to a selecting operation, and the relationship establishing module 15 links the object and the login account and associated password to the selected account and associated password. In another embodiment, the method further includes sub steps: the adding module 19 prompts the user to input an account and associated password in response to the linking request, and the relationship establishing module 15 links the object and the login account and associated password to the input account and associated password.

The method further includes a sub step: the timer module 101 records a time range between a time when the account and associated password stored in the storage unit 22 is last used and a current time. The time comparing module 102 compares whether the time range is more than a predetermined time range, and the deleting module 103 deletes the account and associated password from the storage unit 22 when the time range is more than the predetermined time range.

Although various embodiments have been specifically described, the disclosure is not to be construed as being limited thereto. Various changes or modifications may be made to the embodiments without departing from the scope and spirit of the disclosure.

What is claimed is:

1. An access management system applied between an electronic device and at least one server, wherein the electronic device comprises an input unit and a storage unit, the input unit is for receiving an account and an associated password, the storage unit stores a plurality of accounts and associated passwords which are used to login the electronic device, each account and associated password links to a plurality of objects, each object is assigned a login account and associated password which has a permission to access a server corresponding to the object, the access management system comprising:
one or more processors; and
a plurality of modules to be executed by the one or more processors, wherein the plurality of modules comprises:
a prompting module configured to prompt user to input an account and associated password based on a login request;
a password comparing module configured to compare whether the input account and associated password is one of the accounts and the associated password stored in the storage unit;
a permission acquiring module configured to acquire the plurality of objects linked to the input account and password, and the login account and the associated password for each acquired object when the input account and associated password is one of the accounts and associated passwords stored in the storage unit; and
an implementing module configured to log into one of the objects when the object is accessed.

2. The access management system as described in claim 1, wherein the plurality of modules further comprises:
a relationship establishing module configured to receive a linking request which includes an object and a login account and an associated password for the object, and link the object and the login account and the associated password to one of the accounts and the associated password in response to the linking request.

3. The access management system as described in claim 2, wherein the plurality of modules further comprises:
an acquiring module configured to receive the linking request which includes the object and the login account and the associated password for the object, and acquire the accounts and associated passwords from the storage unit in response to the linking request;
a display module configured to display the acquired accounts and the associated password;
a selecting module configured to select one of the accounts and the associated password in response to a selecting operation; and
the relationship establishing module configured to link the object and the login account and the associated password to the selected account and the associated password.

4. The access management system as described in claim 2, wherein the plurality of modules further comprises:
an adding module configured to prompt the user to input an account and an associated password in response to the linking request; and
the relationship establishing module configured to link the object and the login account and the associated password to the input account and the associated password.

5. The access management system as described in claim 1, wherein the plurality of modules further comprises:
a timer module configured to record a time range between a time when the account and the associated password stored in the storage unit is last used and a current time;
a time comparing module configured to compare whether the time range is more than a predetermined time range; and
a deleting module configured to delete the account and the associated password from the storage unit when the time range is more than the predetermined time range.

6. The access management system as described in claim 2, wherein the relationship establishing module is further configured to receive an amendment request which includes the object and the login account and the associated password amendment for the object, and link the object and the amended login account and the associated password to the account and associated password in response to the amendment request to cover with an original password for the object.

7. An access management method implemented by an access management system being applied between an electronic device and at least one server, wherein the electronic device comprises an input unit and a storage unit, the input unit is for receiving an account and an associated password, the storage unit stores a plurality of accounts and associated passwords which are used to login the electronic device, each account and associated password links to a plurality of objects, each object is assigned a login account and associated password which has a permission to access a server corresponding to the object, the access management method comprising:
prompting user to input an account and an associated password based on a login request;
comparing whether the input account and associated password is one of the accounts and the associated password stored in the storage unit;
acquiring the plurality of objects linked to the input account and the associated password, and the login account and associated password for each acquired object when the input account and associated password is one of the accounts and the associated password stored in the storage unit; and
logging into one of the objects when the object is accessed.

8. The access management method as described in claim 7, further comprising:
receiving a linking request which includes an object and a login account and an associated password for the object, and linking the object and the login account and associated password to one of the accounts and the associated password in response to the linking request.

9. The access management method as described in claim 8, further comprising:
receiving the linking request which includes the object and the login account and associated password for the object, and acquiring the accounts and the associated password from the storage unit in response to the linking request;
displaying the acquired accounts and the associated password;
selecting one of the accounts and the associated password in response to a selecting operation; and
linking the object and the login account and associated password to the selected account and the associated password.

10. The access management method as described in claim 8, further comprising:
prompting the user to input an account and an associated password in response to the linking request; and
linking the object and the login account and associated password to the input account and associated password.

11. The access management method as described in claim 7, further comprising:
recording a time range between a time when the account and associated password stored in the storage unit is last used and a current time;
comparing whether the time range is more than a predetermined time range; and
deleting the account and associated password from the storage unit when the time range is more than the predetermined time range.

12. The access management method as described in claim 8, further comprising:
receiving an amendment request which includes the object and the login account and associated password amendment for the object, and linking the object and the amended login account and associated password to the account and associated password in response to the amendment request to cover with an original password for the object.
